(19) United States
(12) Patent Application Publication
(10) Pub. No.: US 2026/0310600 A1
(43) Pub. Date: Oct. 8, 2026

(54) METHODS AND SYSTEMS FOR METADATA REDUCTION IN PAGED DIRECT MAPPING KEY-VALUE STORES

(71) Applicant: QiSTOR Inc., San Jose, CA (US)

(72) Inventor: Andrew John TOMLIN, San Jose, CA (US)

(73) Assignee: QiSTOR Inc., San Jose, CA (US)

(21) Appl. No.: 19/481,632

(22) PCT Filed: Aug. 6, 2024
(86) PCT No.: PCT/US2024/041055

§ 371 Date: Nov. 5, 2025

Related U.S. Application Data
(60) Provisional application No. 63/518,232, filed on Aug. 8, 2023.

(51) Int. Cl. G06F 12/02

(52) U.S. Cl. CPC G06F 12/0292

(57) ABSTRACT

A Key-Value storage method may include storing Value data in a storage device at a first addressing granularity. Each Value data corresponds to a Key and may be stored along with a respective header in addressing units within the storage device without regard to addressing unit boundaries. Offset values may be stored within the addressing units, each determining a header offset from an addressing boundary to a first header. Full mapping metadata that associates a Key to a location and to a size of each Value data stored in the storage device may be maintained in storage. The location may be specified at a second addressing granularity that uses fewer bits than the first addressing granularity. A portion of the full mapping metadata may be paged in from the storage device into a memory. The location, the size, and an extra bit corresponding to the user key may then be read from memory and one or more addressing units in the storage device corresponding to the location may be scanned based on the header offset to find the first header and a first Value data and subsequent headers and subsequent Value data if present.

### BACKGROUND

Disk and flash storage devices such as Hard Disk Drives and Solid State Drives provide block-based storage via their interfaces. As shown in FIG. 1A, block-based storage devices have standardized logical interfaces to map fixed-size blocks 102, typically 512 bytes or 4096 bytes of data, to a logical block address (LBA) 104. Examples of these interfaces include NVMe, SATA and SCSI.

One of the key challenges in storage systems is that real-world data often does not neatly fit into the fixed-size logical blocks provided by block-based storage devices. To address this, systems implement additional hierarchical mapping mechanisms in software, enabling efficient storage of real-world data that can have a size granularity down to 1 byte.

A common storage mapping interface abstraction that is used to map variable-sized pieces of user data is known as Key-Value, as represented in FIG. 1B. This abstraction provides an application-friendly interface to the storage system by associating each piece of data (the Value data) 108 with a unique identifier (the Key) 106, a user-defined reference. As the Key 106 is user-defined, it is an abstraction that does not rely on the physical location of the data, which is a problem delegated to lower levels. In this system, the user supplies both the Key 106 and the Value data 108 for storage operations, while for retrieval operations, the user provides the Key 106, and the system returns the corresponding Value data 108. This Key-Value mapping allows for rapid and efficient data access, as the Key 106 directly links to the value data 108. The simplicity and versatility of Key-Value stores enable them to handle a wide variety of data types, making them particularly suitable for scalable and adaptable data management solutions. These characteristics render Key-Value stores a fundamental component in contemporary data storage and retrieval systems, providing significant performance benefits and operational efficiency.

To further contrast LBA and Key-Value, the LBA 104 is a device-supplied reference to a fixed-size block 102 in a linear address space 105, while Key-Value is a user-supplied reference to a variable-sized block of data. The Key 106 is a number of user-defined bytes of user-defined length (up to a maximum number), and importantly, unlike an LBA-style mapping system, the Key 106 does not necessarily reference a contiguous set of addresses.

While convenient for applications, the Key-Value mapping system presents several implementation challenges that a simple LBA mapping scheme does not. These include:
the Key is not fixed in size;
the Key is user-defined;
the mapping space is not contiguous;
the Value data is variable sized, and
a variable number of Key-Values may exist in a predetermined storage capacity.

Any Key-Value mapping system must address these issues. Most solutions use hierarchical mapping systems, hash tables, tree structures, and other algorithms to track the location of data. The solutions space is much simpler if all the mapping data can fit into memory. For many solutions, however, not all the mapping information can be fitted into memory, so it must be paged in and out, which incurs a time penalty.

### BRIEF DESCRIPTION OF THE DRAWINGS

FIG. 1A shows a diagram of a conventional logical block address based data storage system.

FIG. 1B shows a basic diagram of a Key-Value based data storage system that may be configured according to embodiments.

FIG. 2 shows a block diagram illustrating paging in of a portion of the full mapping data into memory, in Key-Value storage system that may be configured according to embodiments.

FIG. 3 is a block diagram illustrating a system for the retrieval of a value of a Key-Value pair from a UserKey in a paged mapped Key-Value storage system with which embodiments may be practiced.

FIG. 4 is a diagram that shows the headers, value sizes and wasted space within addressing units.

FIG. 5 is a diagram that shows the headers and greater wasted space associated with smaller sized Value data within addressing units.

FIG. 6 is a diagram showing addressing units in which headers and Value data are not aligned with addressing unit boundaries, according to an embodiment. FIG. 6 also shows the header offset value to a first header within the addressing unit, according to an embodiment.

FIG. 7 is a graph illustrating logarithmic encoding of size metadata, according to an embodiment.

FIG. 8 is a graph illustrating algebraic encoding of size metadata, according to an embodiment.

FIG. 9 is a flowchart of a computer-implemented method according to an embodiment.

FIG. 10 is another flowchart of a computer-implemented method according to an embodiment.

FIG. 11 is a block diagram of a computer system with which aspects of the embodiments described herein may be practiced.

### DETAILED DESCRIPTION

FIG. 2 shows a system in which a storage device 202 stores a full set of mapping metadata 204 and user data 206. The full mapping metadata 204 may be significantly larger than the portion 210 of mapping metadata that can fit in memory 208. As the full mapping metadata 204 may be too large to load in its entirety in the memory 208, only a portion 210 of the full mapping metadata 204 may be paged into the memory 208. Indeed, in a paged mapped Key-Value storage system, metadata mapping information must be stored and retrieved between memory 208 and storage devices 202 during normal operation.

One significant difference between managing fixed-sized blocks in regular storage and Key-Value storage is that the number of objects contained within a Key-Value store is variable. This means that the metadata storage system must also grow in proportion to the number of stored objects and thus must be dynamic in size.

The size of the metadata mapping information becomes a critical problem for a metadata mapping system suitable for managing Key-Value data. There is a tradeoff between the accuracy of location information and the need for searching. Current state-of-the-art solutions include Log Structure Merge, in which location information may be highly abstracted, most often requiring multiple reads and search operations to locate the data, including potentially stale copies. Solutions like Log Structure Merge can result in more than two reads, and those reads can be much larger than the value of interest.

In any solution where searching is to be avoided, there should be a guarantee that there exists a unique piece of metadata mapping information for each Key. Advantageously, the present unique metadata mapping information can avoid more than two reads while retrieving data to find the most up-to-date Key-Value. However, the amount of metadata mapping information in this case is much larger and can be an issue. Significantly, in the present methods and systems, it is guaranteed that a maximum of one read will page in the correct metadata mapping data, and that only one read need be performed to access the data referenced by the Key.

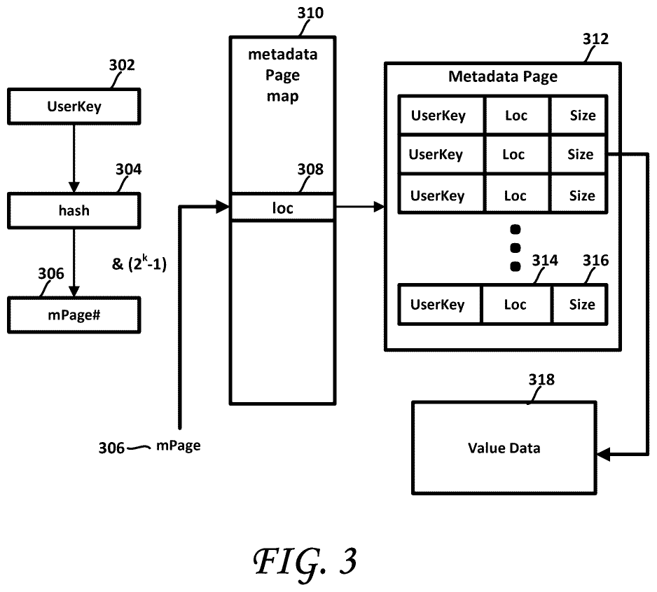

FIG. 3 is a diagram illustrating the retrieval of a value of a Key-Value pair from a UserKey in a paged mapped Key-Value storage system. In FIG. 3, assume that the location information of the Value data for a given user key is contained within a metadata page, where the metadata page contains a maximum number of entries. The metadata page location 308 may be obtained by indexing into a metadata page map 310 based on the metadata page number 306. The metadata page number 306 may be obtained by generating a hash 304 of the user Key 302 and then masking the hashed user Key based on the number of metadata pages in the system. Note that it is possible that the metadata page identified in this scheme is not written yet, so the location of the metadata page 308 indexed by the metadata page number 306 may be zero. In this case, the mask may be modified to (2^{k-d}−1), where 2^{k} is the number of entries in the metadata page map 310. The operation may be repeated with d=1 and then d=2 and so on, until a written metadata page is found. Note that this repeated masking operation is part of the scheme that allows the metadata page map 310 to grow in size over time.

As an example of a retrieval operation, assume a request is made to access a first Key. In this example embodiment, a UserKey 302 may be hashed at 304 to create an internal first hash, as follows:

$${hash}_{1} = f ( {Key}_{1} )$$

The metadata for the first Key is contained in a first Metadata Page (mPage₁) 312. If the metadata map is of size 2^{k} entries then the metadata page is obtained as:

$${mPage}_{1} = {hash}_{1} \& ( {2}^{k} - 1 )$$

The location 308 of mPage1 can then be looked up in the memory in the metadata page map 310. Assuming, for simplicity, that this metadata page is indeed written, a read to the media may then be performed to load the first metadata page 312 in memory. Once loaded, the first metadata page 312 may be searched to find the first user Key. Once found, the location and length or size information of the Value data corresponding to the found first user Key may then be used to issue reads to the media to load the Value data 318 stored at that location and return the loaded Value data 318 to the host.

The number of bits of metadata required to specify the location 314 and size 316 information of the Value data referenced by the user Key contained inside the metadata page is a critical design parameter. The embodiments described, shown, and claimed herein reduce the number of metadata bits used for the location information 314 needed for the retrieval of the Value data, and the number of bits used for the size information 316 of the Value data, used for value retrieval and storage system management. As shown in FIG. 3, both the location information and size information are stored in the metadata mapping system on a per-Key basis, with each user Key being associated with exactly one pair of location and size information.

Mapping information for a given Key value may include metadata comprising at least a location (address) and the size of the Value data stored in the media of the storage device. A location is an address within a defined address space, where each address space contains a fixed amount of data; the size of the fixed amount of data is also known as the addressing granularity. For example, a 4 byte addressing granularity means that 4 bytes of data are stored at every addressable location. In the standard LBA scheme, 512 or 4096 bytes of data are stored per addressable location. However, addressing granularity directly impacts the size of the metadata needed to record the address. If the storage space is 2ⁿ and the mapping or addressing granularity is 2^{m}, then the number of bits needed to record an addressing location is (n-m). This means that higher precision location information (smaller m) needs a greater number of bits than is required for comparatively lower precision location information (larger m).

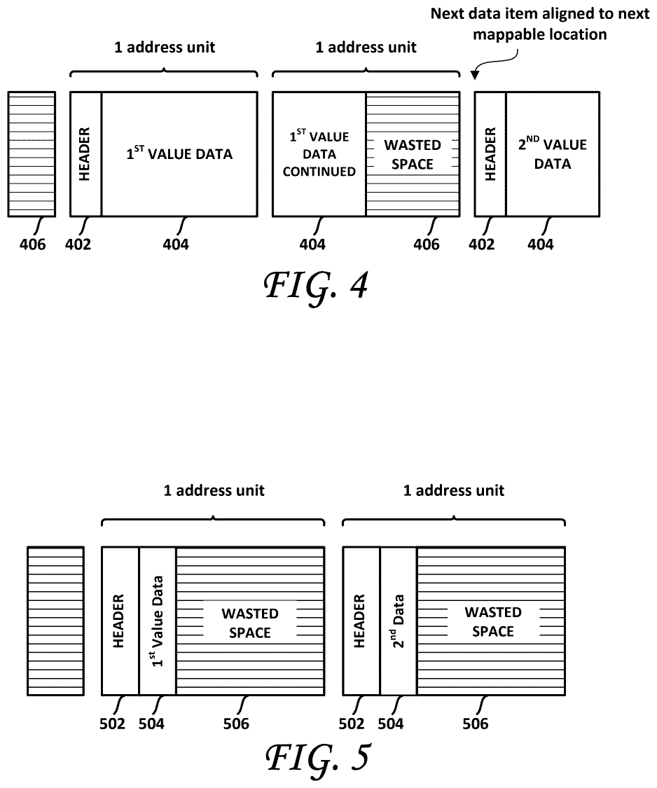

As shown in FIG. 4, each of the header 402 and Value data 404 combinations are aligned to storage addressing unit boundaries, so a maximum of one Key-Value pair (402, 404) can be stored per addressing unit. In one implementation, the headers 402 may include the header type, a compressed flag, Cyclic Redundancy Check (CRC), the Key, and the compressed and uncompressed lengths of the Value data. For a given addressing granularity, the length of the Value data 404 may not precisely fill the available space between headers 402, with smaller Value data resulting in a greater amount of wasted space (space that is not filled by headers or Value data) 406 and with larger Value data resulting in a smaller amount of wasted space 406.

Indeed, as the average length or size of the Value data becomes smaller than the addressing granularity (value size<<m), the efficiency loss becomes higher, as shown in FIG. 5. In FIG. 5, the header 502 is stored at the addressing unit boundary and the Value data 504 is stored immediately adjacent to the header 502. In FIG. 5, as the size of the Value data 504 is much smaller than the addressing granularity (which, in turn, determines the addressing unit boundaries), much of the otherwise-available storage space in each addressable unit is unused and can be considered to be wasted space, as shown at reference 506. On average, the wasted space per Key-Value is 50% of the address granularity and the amount of such wasted space becomes gradually smaller until the addressing granularity is one byte, at which point no space is wasted, as every consecutive byte is individually addressable.

The embodiments disclosed herein address both of these problems; namely the size of the location information and the length (size) of the size information stored in the full mapping metadata, a portion of which is paged, in use, in memory. In one embodiment, the location precision is decoupled from the storage packing using a low-resolution (high m) location pointer. According to an embodiment, the header may no longer be constrained to be aligned with the addressing unit boundary and may be augmented by a header offset value that may be used by a scanning scheme to find the first header (and subsequent headers) in the addressing unit. The scanning scheme is a secondary mechanism that is configured to enable the extraction of fine-grained positioning of the Value data within an addressing unit and the subsequent more efficient data packing. The coarse (lower) resolution is used to read a section of data (i.e., one or more addressing units) into a buffer, and then the header offset to the header (and thus to the first Value data) is fed to a scanning position resolver. The time required to carry out such a scanning process is many orders of magnitude faster than the read time. Accordingly, as the Value data is packed and stored at a finer granularity of location than is tracked by the metadata management system, the Value data can be packed with much higher efficiency, minimizing, or eliminating wasted space.

The optimum solution may be obtained when the minimum unit of reading and writing is the same as the resolution of the location pointer. However, the header's lack of alignment restriction may require an extra read.

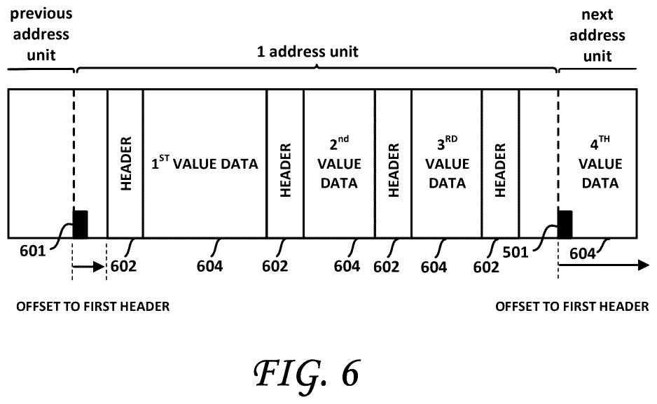

As foreshadowed above and according to an embodiment, a small entry called an header offset 601, shown in FIG. 6, may be stored at the beginning of (or at some other predetermined location within) every addressing unit. The header offset 601, according to an embodiment, indicates the offset from the location within the addressing unit of the header offset value 601 to the location of the first header 602 in the addressing unit. The location of the header offset 602 may, but need not be, at the leading addressing unit boundary. In one implementation, the headers 602 may include the header type, a compressed flag, CRC, the Key, and the compressed and uncompressed lengths of the Value data. If the addressing unit does not contain headers 602, the header offset 601 may be set to zero. As shown in FIG. 6, the data elements (the headers 602 and the Value data 604) may be advantageously packed into mappable addressing units without regard to alignment to the mappable addressing units' boundaries. In turn, this enables headers 602 to begin anywhere within an addressing unit and enables several headers 602 and several Value data 604 to be stored within a single addressing unit. Moreover, a Value data 604 may span more than one addressing unit.

To read a first Value data, and as described relative to FIG. 3, a UserKey may be hashed to create an internal first hash, which may then be used to determine a first Metadata Page, the location of which may be determined from the metadata page map 310. A read to the media may then be performed to load the first metadata page in memory. To read the first Value data, the addressing unit indicated by the location metadata in the loaded metadata page may be accessed. Then, after reading the header offset 601 to the first header 602, the first and subsequent headers 602 contained within the addressing unit in memory may be found and compared to the UserKey to find the header 602 and Value data 604 of interest. It should be noted that the Value data may be stored within the addressing unit with no packing efficiency loss—no wasted space. As the location of the header 602 preceding the Value data 604 of interest is now approximated, with its lower precision, an extra bit may be stored in the metadata to indicate whether an additional addressing unit needs to be read on retrieval beyond that calculated based on the length (size), as the Value data can span more than one addressing unit boundary. Indeed, the Extra bit accounts for cases in which the Value data starts at a non-zero offset and, because of this offset, crosses an extra addressing unit boundary. In the above example, and as shown in FIG. 6, the first, second, and third Value data 604 are referenced at the addressing unit, and the extra bit would not be set. The fourth Value data, assuming its length is less than one addressing unit, would have its extra bit set, as the fourth Value data 604 is stored in more than one addressing unit, despite it's short length. The presence of the set extra bit allows read length calculation correction at retrieval time. It is possible to omit this bit and to perform additional read if necessary during retrieval. However, this may be undesirable due to the negative impact of additional latency.

In this manner and according to an embodiment, the number of addressing units to read (readUnits) into memory at an addressing granularity 2^{m}, rounding fractional values up, becomes:

$$readUnits = \frac{{Value}_{length}}{{2}^{m}} + Extra$$

In one aspect, an embodiment relates to reducing the number of metadata bits required to store the location information corresponding to a user Key, to enable the metadata management system to track the location of the Value data in the storage media. As the Value data is packed and stored at a finer granularity than is tracked by the metadata management system, the size of the location metadata is correspondingly decreased.

Another embodiment addresses the issue of the length of the size information of the Value data. The size metadata of the user Value data is stored in the metadata system. Values are provided by the host at byte-level length granularity, which is expensive from a metadata management perspective, both in terms of metadata storage space and time. It is, in fact, desirable to record this size metadata with maximum (byte) level resolution for optimal system efficiency. Anything other than byte-level resolution results in some reduction of the mapping system efficiency. However, byte-level resolution requires more bits to store the size information, creating more overhead and consequential efficiency loss. For an effective metadata mapping system, high accuracy of the size metadata is important. Any precision loss in the size information will result in the accumulation of free space calculation errors in the system, which will degrade the free space accounting and result in efficiency losses in the mapping system as a whole. This error accumulation is proportional to the number of objects in the space. This also implies that errors in small objects (greater accumulation of free space errors) are a bigger problem than errors in large objects (which are associated with comparatively smaller accumulation of free space errors).

One embodiment takes advantage of the fact that mapping system efficiency loss is related to the size of the user Value data being stored. Indeed, it has been found that inaccuracy in the size metadata of small Value data causes a larger mapping system efficiency loss than inaccuracy in the size metadata of larger Value data. In other words, the mapping system efficiency loss is inversely proportional to value size metadata, with greater metadata mapping efficiency losses being associated with the size metadata of small Value data and comparatively smaller metadata mapping efficiency losses being associated with the size metadata of larger Value data.

Effectiveness is different from efficiency. According to embodiments, efficiency may be measured as follows:

$$efficiency = \frac{user data}{( user data + overhead )}$$

For example, the headers can be considered to be overhead and contribute to efficiency loss. Such overhead includes headers, mapping information and any other space used for metadata; i.e., anything other than user data. One embodiment, therefore, is directed to encoding the size metadata of smaller Value data differently than the size metadata of comparatively larger Value data.

Assume Value data can have a maximum size of 2^{v} bytes. The unencoded length, therefore, is v bits. However, as additional header and other information are present, one implementation requires v+1 bits. The size metadata may be encoded using w bits, to thereby save (v+1)-w bits.

In one embodiment, the size metadata may be logarithmically encoded, such that the number space is divided logarithmically. If this logarithmic size is encoded in w bits, there are 2^{w} unique length values. The logarithmically-encoded size may be calculated with a length offset to account for the header, as follows:

$${length}_{v a l u e} = {10}^{( ( \frac{log ( {length}_{max} ) - log ( {length}_{min} )}{{2}^{w}} ) \times {length}_{encoded} )}$$

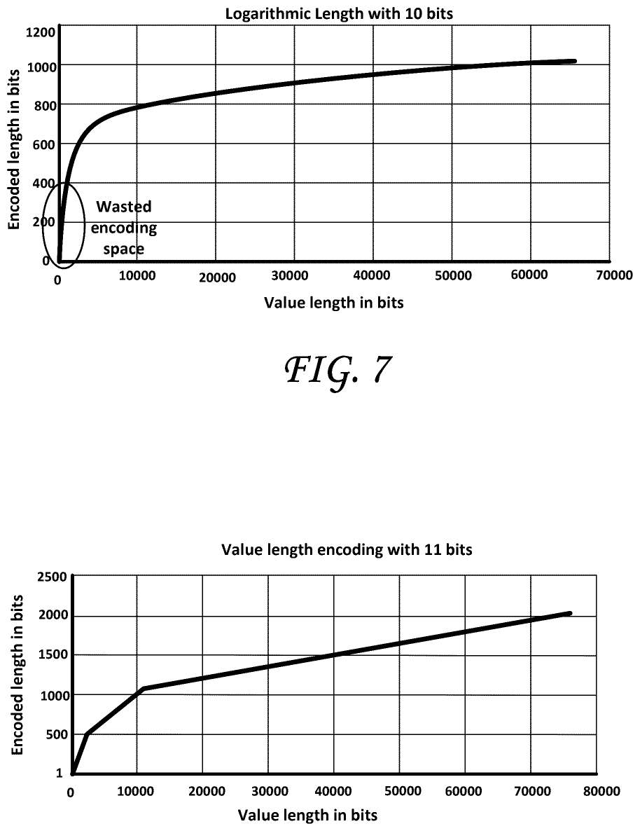

The logarithmic scheme has the disadvantage of wasting information space for fractional sizes of less than 1 byte from an encoding efficiency perspective. That is, for small sizes of less than 1 byte, multiple encoded bit values map to the same byte value length, as shown in FIG. 7. This is shown as “Wasted encoding space” at the base of the graph of FIG. 7, where there is not a one-to-one relationship between the unencoded size metadata and the encoded size metadata over the entire size range. Additionally, the logic necessary to handle logarithmic calculation incurs additional processing cost. The logarithmic encoding in the example shown in FIG. 7 is encoded using 10 bits, for 2¹⁰ unique length values.

An alternative scheme is to use an algebraic approximation to logarithmic encoding where each encoded size bit value maps to a unique unencoded size, in a one-to-one relationship, as shown in FIG. 8. Recall that, in this embodiment, the size metadata of smaller Value data may be encoded differently than comparatively larger values are encoded, thereby reducing the otherwise fixed metadata sizes, and reducing the overall storage requirements for the size metadata. For example, in one implementation, the size metadata for small Value data may be encoded in increments of 2 bytes, up to a certain threshold, beyond that increments of 4 bytes, then increments of 8 bytes, then increments of 16 bytes, and the metadata for larger Value data may be encoded in increments of 64 bytes.

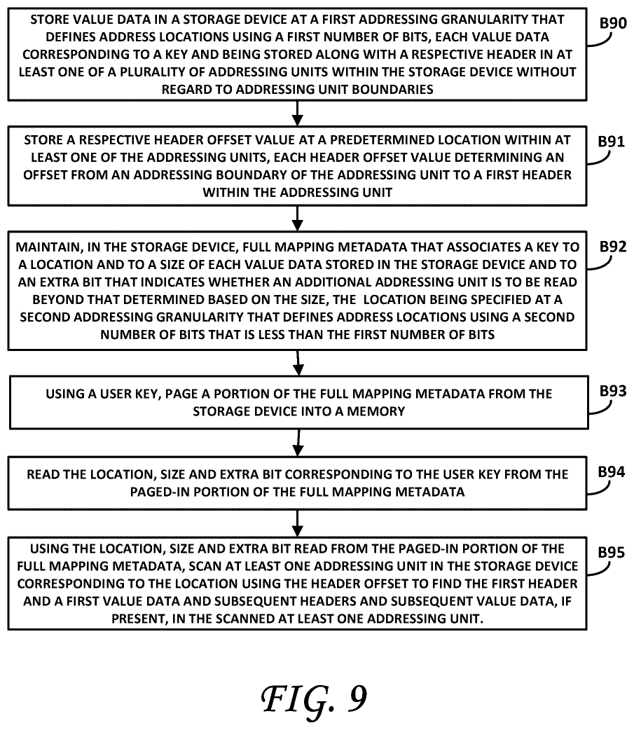

FIG. 9 is a flowchart of a computer-implemented method according to an embodiment. As shown in FIG. 9, a computer-implemented method of implementing a Key-Value storage system may include, as shown at block B90, storing Value data in a storage device at a first addressing granularity that defines address locations using a first number of bits, with each Value data corresponding to a Key and being stored along with a respective header in one or more of a plurality of addressing units within the storage device without regard to addressing unit boundaries. As shown at block B91, a respective header offset value may be stored at a predetermined location within at least one of the addressing units, with each header offset value determining an offset from an addressing boundary of the addressing unit to a first header within the addressing unit. B92 calls for maintaining, in the storage device, full mapping metadata that associates a Key to a location and size of each Value data stored in the storage device and to an extra bit that indicates whether an additional addressing unit is to be read beyond that determined based on the size. According to an embodiment, the location may be specified at a second, coarser addressing granularity that defines address locations using a second number of bits that is less than the first number of bits. As shown at B93, using a user key, a portion of the full mapping metadata may be paged in from the storage device into a memory. At B94, the location, the size, and the extra bit corresponding to the user key may be read from the paged-in portion of the full mapping metadata. Finally at B95, using the location, the size, and the extra bit read from the paged-in portion of the full mapping metadata, one or more addressing units in the storage device corresponding to the location may be scanned using the header offset to find the first header and a first Value data and subsequent headers and subsequent Value data, if present, in the scanned at least one addressing unit.

According to further embodiments, storing the Value data in the storage device may be carried out in such a manner as to eliminate or minimize wasted space within each of the plurality of addressing units. Storing the Value data in the storage device may be carried out in such a manner that at least some of the headers and Value data are stored contiguously. In one embodiment, the portion of the full mapping data may comprise at least a number of addressing units defined by

$$\frac{{Value}_{length}}{{2}^{m}} + Extra$$

where Value_{Length} is a length of Value data, 2^{m} is the second addressing granularity, and Extra is an additional bit to account for instances, due to alignment, in which the read length of the Value data calculated from the Value data length spans one additional addressing unit.

In another embodiment, the computer-implemented method may comprise encoding the size of Value data stored in the full mapping metadata such that smaller Value data is encoded differently than larger Value data. It is to be noted, however, that the number of bits of the size metadata field 316 is the same size for all Value data, once an encoding is selected. In one implementation, the encoding of the size of Value data stored in the full mapping metadata may be carried out using a logarithmic encoding scheme. In another implementation, the encoding of the size of each Value data stored in the full mapping metadata may be carried out using an algebraic encoding scheme that is piecewise linear for predetermined ranges of Value data. For example, the encoding of the size of Value data stored in the full mapping metadata may be carried out in increments of 2 bytes up to a first predetermined size of the Value data, in increments of 4 bytes up to a second predetermined size of the Value data, in increments of 8 bytes up to a third predetermined size of the Value data, in increments of 16 bytes up to a fourth predetermined size of the Value data and in increments of 64 bytes for Value data that are larger than the fourth predetermined size of Value data.

Another embodiment is a Key-Value data storage system that may include a storage device, the storage device being configured to store user data at a first addressing granularity, the user data being accessible via a Key-Value system; a memory and a at least one processor. A plurality of processes may be spawned by the processor, and the plurality of processes may comprise processing logic to: store Value data in a storage device at a first addressing granularity that defines address locations using a first number of bits, with each Value data corresponding to a Key and being stored along with a respective header in at least one of a plurality of addressing units within the storage device without regard to addressing unit boundaries; store a respective header offset value at a predetermined location within at least one of the addressing units, each header offset value determining an offset from an addressing boundary of the addressing unit to a first header within the addressing unit; maintain, in the storage device, full mapping metadata that associates a Key to a location and to a size of each Value data stored in the storage device, the location being specified at a second addressing granularity that defines address locations using a second number of bits that is less than the first number of bits; using a user key, page a portion of the full mapping metadata from the storage device into the memory; read the location, the size, and extra bit corresponding to the user key from the paged-in portion of the full mapping metadata, and using the location, the size, and extra bit read from the paged-in portion of the full mapping metadata, scan at least one addressing unit in the storage device corresponding to the location to find the first header and a first Value data and subsequent headers and subsequent Value data, if present, in the scanned at least one addressing unit.

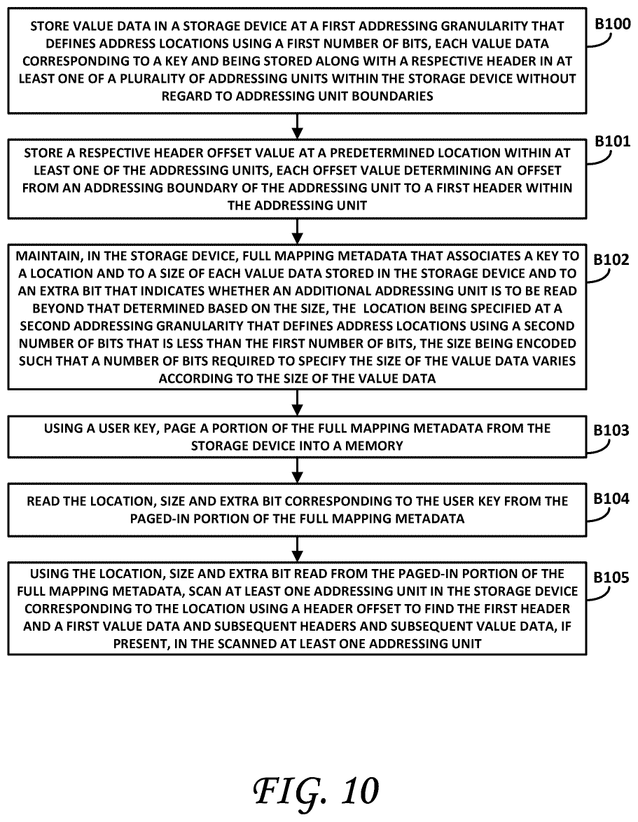

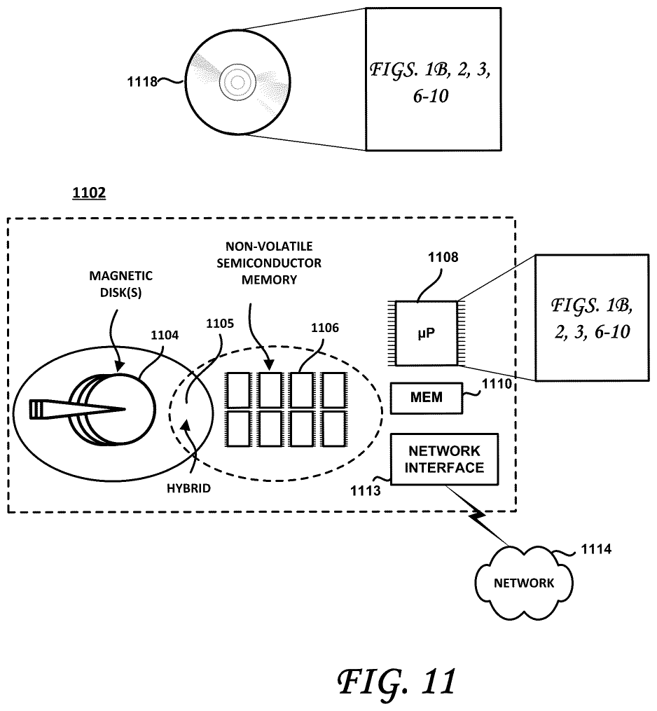

FIG. 10 is a flowchart of a computer-implemented method of implementing a Key-Value store system according to another embodiment. As shown therein, in Block B100, Value data may be stored in a storage device at a first addressing granularity that defines address locations using a first number of bits. Each Value data corresponds to a Key and may be stored along with a respective header in at least one of a plurality of addressing units within the storage device without regard to addressing unit boundaries. B101 calls for storing a respective header offset value at a predetermined location within at least one of the addressing units, each header offset value determining an offset from an addressing boundary of the addressing unit to a first header within the addressing unit. In Block B102, full mapping metadata may be maintained in the storage device. The full mapping metadata associates a Key at least to a location and to a size of each Value data stored in the storage device. In this embodiment, the location may be specified at a second addressing granularity that defines address locations using a second number of bits that is less than the first number of bits, the size of the Value data being encoded differently for smaller Value data than for larger Value data. It is to be noted that the number of bits of the size metadata field 316 is the same size for all Value data, once an encoding is selected. As shown at B103, a portion of the full mapping metadata, using a user key, may be paged in from the storage device into the memory. B104 calls for reading the location, the size, and the extra bit corresponding to the user key from the paged-in portion of the full mapping metadata. Finally, in B105, using the location, the size, and the extra bit read from the paged-in portion of the full mapping metadata, one or more addressing units in the storage device corresponding to the location may be scanned based on a first header offset to find the first header and a first Value data and subsequent headers and subsequent Value data, if present, in the scanned at least one addressing unit.

In other embodiments, the size may be encoded such that a precision of smaller Value data is higher than a precision than the sizes of comparatively larger Value data. The size may be encoded using a logarithmic encoding scheme or may be encoded using an algebraic encoding scheme that is piecewise linear for predetermined ranges of sizes of the Value data. In one embodiment, the header offset may be stored within each addressing unit at a predetermined location, each header offset specifying an offset from an addressing boundary of the addressing unit to a first header within the addressing unit. In another embodiment, the full mapping metadata may further store the header offset.

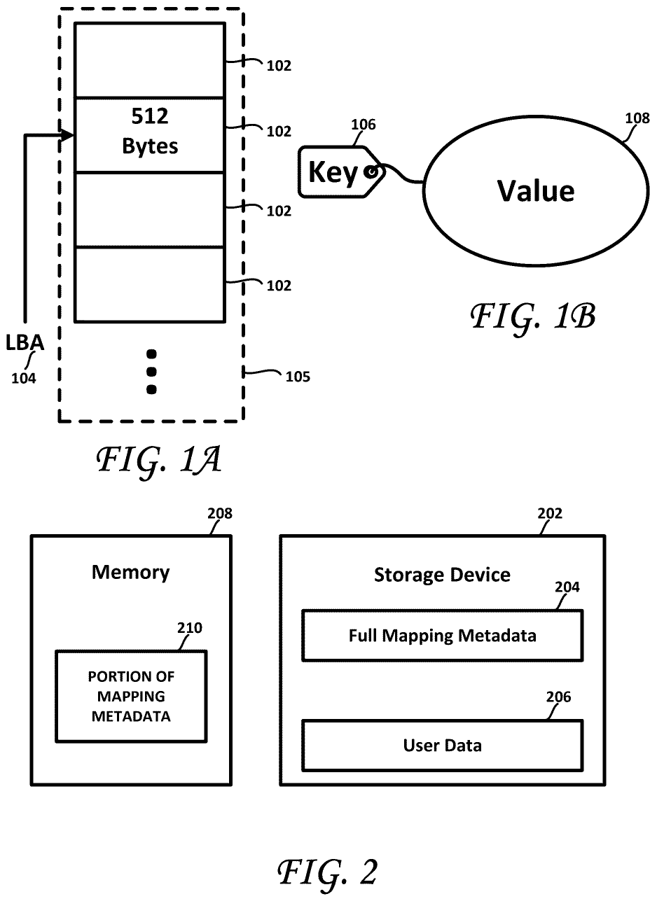

FIG. 11 a computer system configured to execute the computer-implemented methods shown and described herein. According to one embodiment, the computer system may comprise at least storage media 1104, 1105, 1106, at least one processor 1108, memory 1110 and a network interface 1113. A plurality of processes may be spawned by the processor 1108, which plurality of processes may comprise processing logic to carry out the functionality shown and described at least relative to FIGS. 1B, 2, 3 and 6-10. FIG. 11 also shows exemplary tangible, non-transitory computer-readable media 1118 having data stored thereon representing sequences of instructions which, when executed by the computer system, cause the computer system to carry out a computer-implemented method of reducing a size of mapping metadata in a Key-Value store system according to one or more of the embodiments described herein.

Discussing now FIG. 11 in greater detail, the computer system may comprise direct access data storage devices such as magnetic disks 1104, non-volatile semiconductor memories (EEPROM, Flash, etc.) 1106, a hybrid data storage device 1105 comprising both magnetic disks 1104 and non-volatile semiconductor memories, one or more microprocessors 1108 and volatile memory 1110. The computer system may also comprise a network interface 1113, configured to communicate over network 1114 with remote servers, storage services and the like. References 1104, 1105, 1106 and 1118 are examples of tangible, non-transitory computer-readable media having data stored thereon representing sequences of instructions or processing logic which, when executed by the computer system, cause the computer system to carry out the computer implemented methods described herein and shown at least relative to FIGS. 1, 2, 3 and 6-10. Some of these instructions may be stored locally in the computer system 1102, while others of these instructions may be stored (and/or executed) remotely and communicated to the computer system 1102 over the network 1114. In other embodiments, all these instructions may be stored locally in the computer system 1102, while in still other embodiments, all of these instructions are stored and executed remotely, and the results communicated to the computer system 1102. In another embodiment, the instructions may be stored on another form of a tangible, non-transitory computer readable medium, such as shown at 1118. For example, reference 1118 may be implemented as an optical or magnetic disk (and/or other forms of storage), which may constitute a suitable data carrier to load the instructions stored thereon onto the computer system 1102, thereby re-configuring the computer system to one or more of the embodiments described and shown herein.

In the foregoing description, numerous specific details are set forth in order to provide a thorough understanding of one or more aspects and/or features of the exemplary embodiments. It will be apparent to one skilled in the art, however, that one or more aspects and/or features described herein may be omitted in favor of others or omitted all together. Herein, each described and/or shown important feature, structure or functionality can be isolated from the others. Thus, individual aspects, features, structures described in relation to one embodiment may be used in, added to, or substituted in in relation to another embodiment. In some instances, the description of well-known process steps and/or structures are omitted for clarity or for the sake of brevity.

Herein, devices or processes that are described as being in communication with each other need not be in continuous communication with each other, unless expressly specified otherwise. In addition, devices or processes that are disclosed to be in communication with one another may communicate directly or indirectly through one or more intermediaries.

Further, although constituent steps of methods have been described in a sequential order, such methods may be configured to work in alternate orders. In other words, any sequence or order of steps that may be described herein does not, in and of itself, indicate a requirement that the steps be performed in that order. The steps of described processes may be performed in an order that differs from the order described herein. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred over other processes.

When a single device or article is described, it will be readily apparent that more than one device/article (e.g., whether or not they cooperate) may be used in place of a single device/article. Similarly, where more than one device or article is described (e.g., whether or not they cooperate), it will be readily apparent that a single device/article may be used in place of the more than one device or article. The functionality and/or the features of a device may be alternatively embodied by one or more other devices that are not explicitly described as having such functionality/features.

Lastly, while certain embodiments of the disclosure have been described, these embodiments have been presented by way of example only and are not intended to limit the scope of the disclosure. Indeed, the novel methods, devices and systems described herein may be embodied in a variety of other forms. Furthermore, various omissions, substitutions, and changes in the form of the methods and systems described herein may be made without departing from the spirit of the disclosure. The accompanying claims and their equivalents are intended to cover such forms or modifications as would fall within the scope and spirit of the disclosure. For example, those skilled in the art will appreciate that in various embodiments, the actual physical and logical structures may differ from those shown in the figures. Depending on the embodiment, certain steps described in the example above may be removed, others may be added. Also, the features and attributes of the specific embodiments disclosed above may be combined in different ways to form additional embodiments, all of which fall within the scope of the present disclosure. Although the present disclosure provides certain preferred embodiments and applications, other embodiments that are apparent to those of ordinary skill in the art, including embodiments which do not provide all the features and advantages set forth herein, are also within the scope of this disclosure. Accordingly, the scope of the present disclosure is intended to be defined only by reference to the appended claims.

1. A computer-implemented method of implementing a Key-Value storage system, the computer-implemented method comprising:
storing Value data in a storage device at a first addressing granularity that defines address locations using a first number of bits, each Value data corresponding to a Key and being stored along with a respective header in at least one of a plurality of addressing units within the storage device without regard to addressing unit boundaries;
storing a respective header offset value at a predetermined location within at least one of the addressing units, each header offset value determining an offset from an addressing boundary of the addressing unit to a first header within the addressing unit;
maintaining, in the storage device, full mapping metadata that associates a Key to a location and to a size of each Value data stored in the storage device and to an extra bit that indicates whether an additional addressing unit is to be read beyond that determined based on the size, the location being specified at a second addressing granularity that defines address locations using a second number of bits that is less than the first number of bits;
using a user key, paging a portion of the full mapping metadata from the storage device into a memory;
reading the location, the size, and the extra bit corresponding to the user key from the paged-in portion of the full mapping metadata, and
using the location, the size, and the extra bit, read from the paged-in portion of the full mapping metadata, scanning at least one addressing unit in the storage device corresponding to the location based on a first header offset to find the first header and a first Value data and subsequent headers and subsequent Value data, if present, in the scanned at least one addressing unit.

2. The computer-implemented method of claim 1, wherein storing the Value data in the storage device is carried out in such a manner as to eliminate or minimize wasted space within each of the plurality of addressing units.

3. The computer-implemented method of claim 1, wherein storing the Value data in the storage device is carried out in such a manner that at least some of the headers and Value data are stored contiguously.

4. The computer-implemented method of claim 1, wherein the portion of the full mapping data comprises at least a number of addressing units defined by
$$\frac{{Value}_{length}}{{2}^{m}} + Extra ,$$
where Value_{Length} is a length of Value data, 2^{m} is the second addressing granularity and Extra is an additional bit to account for instances in which a Value data spans more than one addressing unit of the plurality of addressing units.

5. The computer-implemented method of claim 1, further comprising encoding the size of Value data stored in the full mapping metadata such that a precision of smaller Value data is higher than a precision of comparatively larger Value data.

6. The computer-implemented method of claim 5, wherein encoding the size of Value data stored in the full mapping metadata is carried out using a logarithmic encoding scheme.

7. The computer-implemented method of claim 5 wherein encoding the size of Value data stored in the full mapping metadata is carried out using an algebraic encoding scheme that is piecewise linear for predetermined ranges of Value data.

8. The computer-implemented method of claim 7, wherein encoding the size of each Value data stored in the full mapping metadata is carried out in increments of 2 bytes up to a first predetermined size of the Value data, in increments of 4 bytes up to a second predetermined size of the Value data, in increments of 8 bytes up to a third predetermined size of the Value data, in increments of 16 bytes up to a fourth predetermined size of the Value data and in increments of 64 bytes for Value data that are larger than the fourth predetermined size of Value data.

9. A Key-Value data storage system, comprising:
a storage device, the storage device being configured to store user data at a first addressing granularity, the user data being accessible via a Key-Value system;
a memory;
at least one processor;
a plurality of processes spawned by the processor, the plurality of processes comprising processing logic to:
store Value data in a storage device at a first addressing granularity that defines address locations using a first number of bits, each Value data corresponding to a Key and being stored along with a respective header in at least one of a plurality of addressing units within the storage device without regard to addressing unit boundaries;
store a respective header offset value at a predetermined location within at least one of the addressing units, each header offset value determining an offset from an addressing boundary of the addressing unit to a first header within the addressing unit;
maintain, in the storage device, full mapping metadata that associates a Key to a location and to a size of each Value data stored in the storage device and to an extra bit that indicates whether an additional addressing unit is to be read beyond that determined based on the size, the location being specified at a second addressing granularity that defines address locations using a second number of bits that is less than the first number of bits;
using a user key, page a portion of the full mapping metadata from the storage device into the memory,
read the location, the size, and the extra bit corresponding to the user key from the paged-in portion of the full mapping metadata, and
using the location, the size, and the extra bit read from the paged-in portion of the full mapping metadata, scan at least one addressing unit in the storage device corresponding to the location based on the header offset to find the first header and a first Value data and subsequent headers and subsequent Value data, if present, in the scanned at least one addressing unit.

10. The Key-Value data storage system of claim 9, wherein storing the Value data in the storage device is carried out in such a manner as to eliminate or minimize wasted space within each of the plurality of addressing units.

11. The Key-Value data storage system of claim 9, wherein storing the Value data in the storage device is carried out in such a manner that at least some of the headers and Value data are stored contiguously.

12. The Key-Value data storage system of claim 9, wherein the portion of the full mapping data comprises at least a number of addressing units defined by
$$\frac{{Value}_{length}}{{2}^{m}} + Extra ,$$
where Value_{Length} is a length of Value data, 2^{m} is the second addressing granularity and Extra is an additional bit to account for instances in which a Value data spans more than one addressing unit of the plurality of addressing units.

13. The Key-Value data storage system of claim 9, further comprising encoding the size of each Value data stored in the full mapping metadata such that a precision of smaller Value data is higher than a precision than the sizes of comparatively larger Value data.

14. The Key-Value data storage system of claim 13, wherein encoding the size of each Value data stored in the full mapping metadata is carried out using a logarithmic encoding scheme.

15. The Key-Value data storage system of claim 13 wherein encoding the size of each Value data stored in the full mapping metadata is carried out using an algebraic encoding scheme that is piecewise linear for predetermined ranges of Value data.

16. The computer-implemented method of claim 15, wherein encoding the size of each Value data stored in the full mapping metadata is carried out in increments of 2 bytes up to a first predetermined size of the Value data, in increments of 4 bytes up to a second predetermined size of the Value data, in increments of 8 bytes up to a third predetermined size of the Value data, in increments of 16 bytes up to a fourth predetermined size of the Value data and in increments of 64 bytes for Value data that are larger than the fourth predetermined size of Value data.

17. A computer-implemented method of implementing a Key-Value storage system, the computer-implemented method comprising:
storing Value data in a storage device at a first addressing granularity that defines address locations using a first number of bits, each Value data corresponding to a Key and being stored along with a respective header in at least one of a plurality of addressing units within the storage device without regard to addressing unit boundaries;
maintaining, in the storage device, full mapping metadata that associates a Key to a location and to a size of each Value data stored in the storage device and to an extra bit that indicates whether an additional addressing unit is to be read beyond that determined based on the size, the location being specified at a second addressing granularity that defines address locations using a second number of bits that is less than the first number of bits, the size being encoded such that a precision of smaller value data is higher than a precision of comparatively larger value data;
using a user key, paging a portion of the full mapping metadata from the storage device into a memory;
reading the location, the size, and the extra bit corresponding to the user key from the paged-in portion of the full mapping metadata, and
using the location, the size, and the extra bit, read from the paged-in portion of the full mapping metadata, scanning at least one addressing unit in the storage device corresponding to the location based on a header offset to find the first header and a first Value data and subsequent headers and subsequent Value data, if present, in the scanned at least one addressing unit.

18. The computer-implemented method of claim 17, wherein the size is encoded such that a precision of smaller Value data is higher than a precision than the sizes of comparatively larger Value data.

19. The computer-implemented method of claim 17, wherein the size is encoded using a logarithmic encoding scheme.

20. The computer-implemented method of claim 17, wherein the size is encoded using an algebraic encoding scheme that is piecewise linear for predetermined ranges of sizes of the Value data.

21. The computer-implemented method of claim 17, further comprising storing, within each addressing unit, a respective instance of the header offset at a predetermined location, each header offset specifies an offset from an addressing boundary of the addressing unit to a first header within the addressing unit.

22. The computer-implemented method of claim 17, wherein the full mapping metadata further comprises the header offset that specifies an offset from an addressing boundary of the addressing unit to a first header within the addressing unit.
